(19) United States
(12) Patent Application Publication
(10) Pub. No.: US 2018/0307692 A1
(43) Pub. Date: Oct. 25, 2018

(54) SOFTWARE APPLICATION INTERFACE FOR MEDIATING ACCESS TO SERVICES OF A CENTRALIZED DATA STORE

(71) Applicant: SAP SE, Walldorf (DE)

(72) Inventor: Haibin Yuan, Shanghai (CN)

(73) Assignee: SAP SE, Walldorf (DE)

(21) Appl. No.: 15/492,575

(22) Filed: Apr. 20, 2017

(51) Int. Cl. G06F 17/30; G06F 3/06; G06F 9/54

(52) U.S. Cl. CPC G06F 17/3056; G06F 3/065; G06F 9/547; G06F 17/30589; G06F 3/067; G06F 3/0622; G06F 3/0619

(57) ABSTRACT

A translator component implements an interface that allows a plurality of software applications to access a data store. The interface can include methods for reading data from, or writing data to, the data store. The translator component can form requests to be sent to, and executed by, the data store. The requests can be formed based on the type of call and one or more arguments provided in the call. By using the translator component, the plurality of software applications do not need to implement functionality to directly access the data store, which can facilitate application development, as well as allowing a protocol used to access the data store to be updated or changed without impacting the software applications.

### BACKGROUND

Organizations store increasing amounts of information in database systems or similar data stores. In many cases, a database system can be implemented on one or more computer devices of a computer system, but can be accessed on that computer system, as well as by other computer devices. For instance, an organization may have a central database system that can be accessed by employees, including using desktop computers, laptop computers, table computers, and smartphones. The central database system may be hosted on a cloud computing platform, including a cloud computing platform provided by a third party.

Many end users lack the technical knowledge to access, and interact with, the database system. In order to facilitate activities by end users, more user-friendly software applications are typically provided to simplify operations involving the database system. Rather than using complex interfaces, and specifying operations in a database language, such as the structured query language (SQL), users can access and manipulate data using graphical user interfaces that may be more familiar to the end users, and thus easier for them to use.

However, interacting with database systems can be complicated even for those with computer programming knowledge. A provider of a database system may provide some applications for accessing the database system that are designed for end users. However, the applications may be limited in both number and type, and may be general purpose. These applications may not meet more specific needs of particular organizations or employees.

While it may be possible for custom applications to be developed for use with the database system, the need to interact with the database system can create additional programming requirements for the developing the application, which may be outside the expertise of typical software developers. Even for developers with the necessary expertise, implementing functionality to interact with the database system can increase development time and cost. In addition, the increased development time, cost, and need for specialized knowledge may act to discourage custom application development, which can result in suboptimal utilization of the database system. Whatever use is made of the database system may be less efficient. Thus, room for improvement exists in the area of interfacing software applications with database systems.

### SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

The disclosed innovations relate generally to facilitating interactions between software applications and a centralized data store, such as a database system. The software applications can be located at different computer devices, which may also be different from a computer device or system that implements the centralized data store. The interactions can be facilitated by a translator component, which can implement an interface for mediating access to the centralized data store. The translator component can be located on a different computer system or device than all or a portion of the software applications, or the centralized data store. If desired, the translator component can be located on the same computer system or device as one or more of the software applications or the centralized data store.

An embodiment can be implemented as one or more computer-readable media comprising computer-executable instructions that, when executed, cause a computing system to perform processing to process a call for data source services. The processing includes receiving a call through an interface to access a data store. The call includes one or more arguments. An operation associated with the call is determined, such as an operation to read data from the data store or modify data of the data store. A request template associated with the operation is retrieved. A request is generated, including combining at least one of the one or more arguments with the request template. The request is sent to the data store.

An embodiment can be implemented as a system comprising memory; one or more hardware processors coupled to the memory; and one or more computer-readable media storing instructions that, when loaded into the memory, cause the one or more hardware processors to perform operations for processing a call for services of a remote data store. The operations include implementing an interface for mediating access to the remote data store. The interface provides methods to read and modify data at the remote data store. Calls to interface methods are received from a plurality of applications. At least a portion of the plurality of calls provide one or more arguments for a called method. A request is constructed to be sent to the remote data store using at least one argument provided in a call of the plurality of calls. The request includes a URI and a request body. The request is sent to the remote data store.

An embodiment can be implemented as a method carried out at least in part by a computing system. The method includes receiving calls from a plurality of software applications executed on a plurality of different computer devices to an interface for facilitating access to a remote data store. Each call is specified in a web services protocol. Methods associated with the calls are executed. For at least a portion of the calls, the executing includes generating requests for database operations. The requests are specified in a web services data access protocol and include one or more arguments provided in a respective call. The requests are sent to the remote data store. Execution results are received from the remote data store and provided to the calling applications.

The various innovations can be used in combination or separately. As described herein, a variety of other features and advantages can be incorporated into the technologies as desired. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an architecture in which each of a plurality of software applications implements a data services component for accessing a centralized data store.

FIG. 2 is a block diagram of an architecture providing a translator component for mediating operations requested by a plurality of software applications from a remote data store.

FIG. 3 is a block diagram illustrating components of method calls made by software applications, methods and method libraries provided by an interface of a translator component, and a data store that can be accessed by the software applications using the interface of the translator component.

FIG. 4 is a block diagram of an architecture in which each of a plurality of software applications can request the services of a data store using a common interface provided by a translator component.

FIG. 5 is a flowchart of an example method of a translator component mediating access by a software application to a data store.

FIG. 6 is a flowchart of an example method of providing an interface to allow a plurality of software applications to access a remote data store.

FIG. 7 is a flowchart of an example method for receiving requests from a software application for services of a remote data store and returning execution results to the software application.

FIG. 8 is a diagram of an example computing system in which described embodiments can be implemented.

FIG. 9 is an example cloud-support environment that can be used in conjunction with the technologies described herein.

### DETAILED DESCRIPTION

### Example 1—Example Overview

Organizations store increasing amounts of information in database systems or similar data stores. In many cases, a database system can be implemented on one or more computer devices of a computer system, but can be accessed on that computer system, as well as by other computer devices. For instance, an organization may have a central database system that can be accessed by employees, including using desktop computers, laptop computers, table computers, and smartphones. The central database system may be hosted on a cloud computing platform, including a cloud computing platform provided by a third party.

Many end users lack the technical knowledge to access, and interact with, the database system. In order to facilitate activities by end users, more user-friendly software applications are typically provided to simplify operations involving the database system. Rather than using complex interfaces, and specifying operations in a database language, such as the structured query language (SQL), users can access and manipulate data using graphical user interfaces that may be more familiar to the end users, and thus easier for them to use.

However, interacting with database systems can be complicated even for those with computer programming knowledge. A provider of a database system may provide some applications for accessing the database system that are designed for end users. However, the applications may be limited in both number and type, and may be general purpose. These applications may not meet more specific needs of particular organizations or employees.

While it may be possible for custom applications to be developed for use with the database system, the need to interact with the database system can create additional programming requirements for the developing the application, which may be outside the expertise of typical software developers. Even for developers with the necessary expertise, implementing functionality to interact with the database system can increase development time and cost. In addition, the increased development time, cost, and need for specialized knowledge may act to discourage custom application development, which can result in suboptimal utilization of the database system. Whatever use is made of the database system may be less efficient. Thus, room for improvement exists in the area of interfacing software applications with database systems.

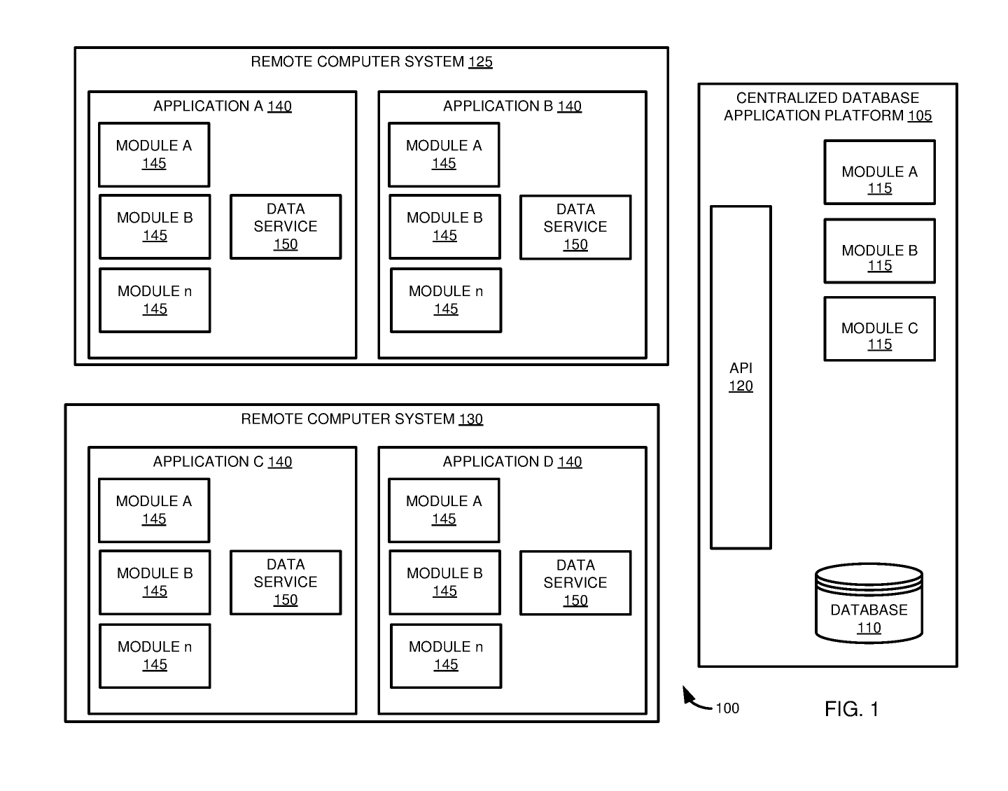

FIG. 1 illustrates an architecture 100 that highlights problems with typical scenarios for applications accessing data at a centralized data source. The architecture 100 includes a centralized database application platform 105. The centralized database application platform 105 includes a database 110 and one or more applications or application modules 115 that provide access to the database 110. For instance, each application module 115 may be configured to assist users in carrying out a specific task, or category of tasks, using the database 110, including retrieving information (e.g., executing queries), updating or deleting database records, or adding records to the database. One such system is the SUCESSFACTORS system, using the HANA database system, both of SAP SE of Walldorf, Germany, which provides many different modules 115 for different human resources activities.

In addition to being accessed by the modules 115, the database 110 can be accessed by remote computer systems or devices 125, 130. The remote computer systems or devices 125, 130 can be, for example, cloud-based computing systems (e.g., the HANA CLOUD PLATFORM of SAP SE, of Walldorf, Germany, AMAZON WEB SERVICES of Amazon.com, Inc., of Seattle, Wash., or AZURE of Microsoft Corp., of Redmond, Wash.).

The remote computer system 125 can represent a centralized cloud platform that may be provided by the provider of the centralized database application platform 105 (e.g., HANA CLOUD PLATFORM) and the remote computer system 130 can represent a server maintained by an organization associated with one or more end users. The remote computer systems 125, 130 each can include or more software applications 140. Each software application 140 can include one or more modules 145, where a module may be configured to facilitate a particular task or category of tasks that a user may be to carry out with respect to data of the database 110. In some cases, one or more of the modules 145 can address the same task or task category as an application module 115 of the centralized database application platform 105.

Each software application 140 accesses the database 110 through a data service 150. Significantly, each application 140 has its own data service 150. Although the remote computer systems 125, 130 are each shown with two applications 140, the remote computer systems can include more applications, and the architecture 100 can include more remote computer systems (or, in some aspects, a single remote computer system) and centralized database application platforms 105 than shown. The architecture 100 illustrates that implementing a new application 140 requires implementing a corresponding data service 150, and, because the data services 150 carry out a particular, common functionality, the effort of connecting an application 140 to the database 110 is to some extent redundant.

The data services 150 can communicate with the database 110 through an application program interface (API) 120. The application program interface 120 can serve to translate calls made to the API into a format usable by the database 110. In particular, the data services 150 and the interface 120 can use a remote database access protocol, including a protocol that complies with representational state transfer principles. In a specific example, the database access protocol is the OData protocol.

Using the OData protocol to interact with the database 110 can require a developer of an application 140 to be familiar with the OData protocol, as well as the interface 120. In some aspects, OData requests can be converted to another format or language prior to being executed on the database 110. For instance, the OData requests can be converted to appropriate SQL operations.

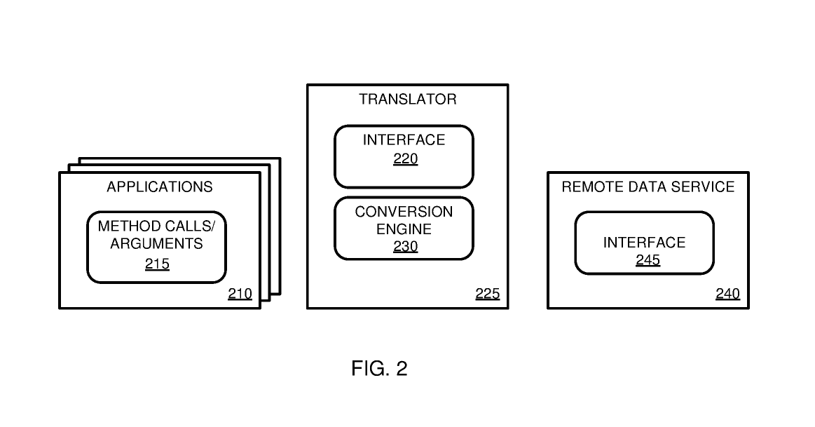

FIG. 2 illustrates how disclosed innovations can facilitate the development of applications that can interact with a database system. FIG. 2 includes a plurality of software applications 210. The software applications 210 can be located at the same computer device or at different computer devices. Each software application 210 can make calls 215, which can optionally have one or more arguments, to an interface 220 of a translator component 225. While the translator component 225 is typically located on a different computer device than the software applications 210, in some aspects the translator component and one or more of the applications can be located on the same computer device.

For each call to the interface 220, an application 210 can provide the identity of a method to be called and, optionally, arguments to be provided for the method. A conversion engine 230 of the translator component 225 can generate an appropriate database request in response to the method identified by the application 210 and any provided arguments. For instance, the conversion engine 230 can format the arguments into an appropriate request in the OData protocol. The translator component 225 can then forward the formatted/converted request to a remote data service 240. In particular aspects, the remote data service 240 can receive the formatted/converted request through an interface 245, and can then generate appropriate commands to execute the request on a database associated with the remote data service.

Using the disclosed innovations can provide a number of advantages. As shown in FIG. 2, multiple applications 210 can access a common translator component 225. Thus, significant coding effort can be saved compared with the architecture 100 of FIG. 1, where each application 140 employs a separate data service 150. As each application 210 can use a common, provided translator component 225, the applications can be developed without a developer having specific knowledge about the protocol used to communicate with the remote data service 240 or the structure of the remote data service. Applications 210 can be developed more quickly, at lower cost, and by a greater variety of programmers, than the applications 140 of FIG. 1. These improvements thus facilitate the development of applications 210 that better suit the needs of organizations and end users, making the users and organizations more efficient and effective, and increasing the utility of data of the remote data service 240.

The innovations can provide additional advantages. For example, once the applications 140 are coded, they may be “locked in” to a particular communication protocol, and even a particular version of a protocol. If the communication protocol used to access the centralized database application platform 105 were changed, the data service 150 for each application 140 would need to be changed, and the application itself may need to be changed. In contrast, using the innovations of the present disclosure, the implementation details of the methods provided by the interface 220 are abstracted for the applications 210. That is, the interface 220 can remain unchanged (or at least the portion useable by the applications 210, new features can be added without disrupting existing applications) even if the implementing methods are changed. The interface methods can be implemented using an updated protocol, a completely different protocol, or the implementation changed for other reasons (e.g., to provide improved performance), and the changes need only be made once, and without affecting the applications 210 or requiring any changes to the applications.

### Example 2—Example Method Call and Translator Component Features

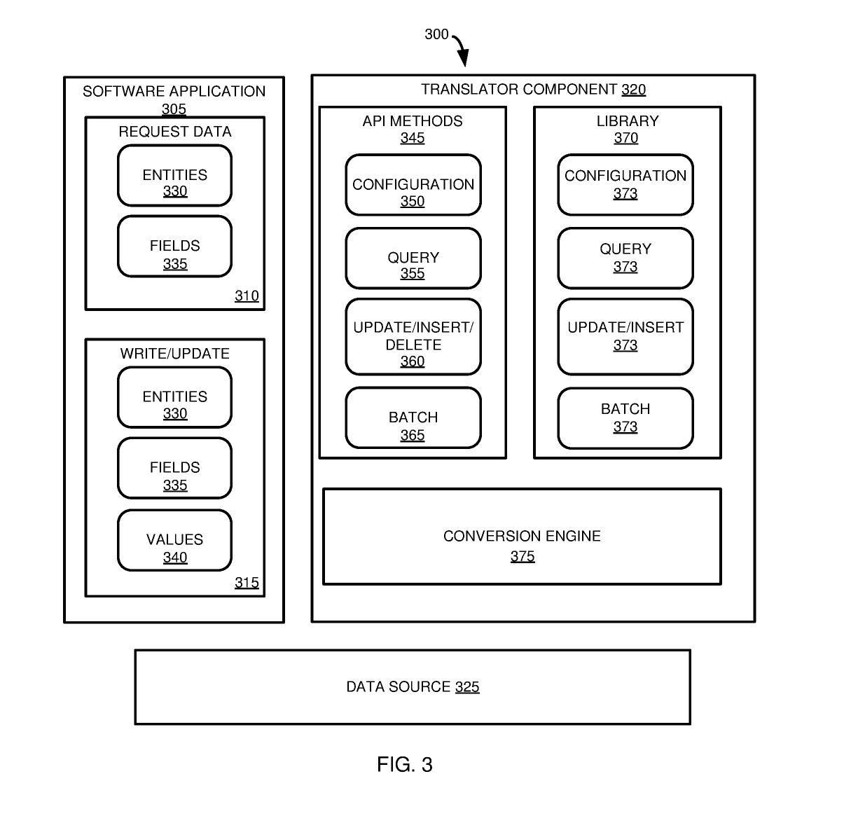

FIG. 3 illustrates an example architecture 300 depicting elements of method calls 310, 315 that may be made by a software application 305 to a translator component 320, which then executes the calls in conjunction with a data source 325 (e.g., a database). Generally, method calls 310, 315 of the software application 305 can be calls 310 to request data (which can be data of the data source 325 or configuration information) or calls 315 to modify data (including creating, updating, or deleting data), which can include altering data of the data source or altering configuration information.

A method call 310 to request data can include entity identifiers 330 and field identifiers 335. Entity identifiers 330 can identify specific data objects (e.g., instances of logical data objects, such as BusinessObjects of SAP SE of Waldorf, Germany, or instances of other abstract or composite data types), one or more data objects meeting particular criteria (e.g., query criteria), specific types of data objects (e.g., customers, products, employees), database tables, database views, and the like. In particular aspects, entity instances (include data for the instance) can be specified in JavaScript Object Notation format, and the data model for the entity can be expressed in the Common Schema Definition Language, which can provide a XML representation of the data model schema.

In some cases, multiple entity identifiers 330 can be included in a method call 310. In other cases, a method call 310 need not include entity identifiers 330. For instance, a method call 310 can request a list of available entity identifiers 330, can request data associated with all (or a selected portion) of available identifiers, can request configuration information, can request schema information (e.g., a data model for an entity), or can request other information.

The method call 310 can also include field identifiers 335. Field identifiers 335 can specify specific data elements (e.g., fields of database tables or data members of instances of a logical data object instance, or instance of a composite or abstract data type) to be retrieved, including particular fields of particular entities specified by the entity identifiers 330. In other cases, the method call 310 does not include field identifiers 335, such as if all data for the entities specified by the entity identifiers is desired, including all data for all entities (in which case the method call 310 may omit both the entity identifier 330 and the field identifiers 335), or if configuration information is requested.

As an example, a user may wish to retrieve information associated with a particular employee of an organization. The employee may be specified by a particular value of an entity identifier 330 (e.g., using the name of the employee or an employee identifier, such as a social security number). In some cases, the user may only wish to retrieve particular information for the employee, such as a birthdate or a social security number, which information can be specified using the field identifiers 335.

Method calls 315 to modify data, such as to write or update data, can also include entity identifiers 330 and field identifiers 335, which can be analogous to the entity identifiers and field identifiers described for the method calls 310. The method calls 315 can also include values 340 to be associated with particular fields 335 of particular entities 330.

The translator component 320 can include interface methods (e.g., API methods) 345 that can be called by the software application 305. The methods 345 can be of various types, including configuration methods 350 (e.g., to set or read various configuration parameters), query methods 355 (e.g., to retrieve selected data), update/insert/delete methods 360, and methods 365 to carry out batch operations.

The translator component 320 can include a library 370 that includes components (e.g., implementations of the interface methods 345) for carrying out the operations made available through the interface methods. For example, a conversion engine 375 of the translator component 320 can determine appropriate request fragments (e.g., OData statements) and insert appropriate arguments from the method calls 310, 315 made by the application 305 into the fragments to form a statement or request that can be processed by the data source 325.

In some aspects, the library 370 can provide request templates 373 for the various types of interface methods 345. The request templates 373 can be implemented as requests that can be sent to, and processed by, the data source 325, and have identifiers to receive arguments that are supplied by a method call of a software application 305. For instance, a call 310, 315 can provide arguments such as a particular data source that is to be read from, or written to, particular database tables or records of the data source (including entity identifiers 330 and field identifiers 335), values to be written to a data source (e.g., values 340), query parameters, variables or entities to receive execution results, and combinations thereof. When a call 310, 315 is made, the conversion engine 375 can insert the arguments provided in the call into the appropriate request template 373, and then send the request to the data source 325 for execution.

Request templates 373 can be implemented in other manners. For instance, rather than having predefined templates into which arguments of a method call 310, 315 are inserted, the templates can be implemented as one or more functions that can build a request to be sent to the remote data source 325. The conversion engine 375 can determine the operations to be carried out in a request and construct the request by inserting the arguments into text (including text representing computer code) such that the combination specifies a request to the remote computer system 325, translating the arguments into appropriate text (including text representing computer code) such that the translated arguments specify a request to the remote computer system, or a combination thereof. Or, combinations of approaches can be used, such inserting arguments into request templates for some calls, or portions thereof, and building a request for other calls, or other call portions.

In particular examples, the remote computer system 325 accepts requests specified in a web services data access protocol, such as the OData protocol. The request can include a URI (in particular, a URL) for the remote computer system, including a specific entity at the remote computer system (e.g., a collection of data objects, such as a table, or a specific data object), and a request body or payload. In specific examples, the request body can be specified in a programming language, such as JAVA or JAVASCRIPT. The request template 373 can include functions to generate the URI and message body, stored text into which arguments from a method call 310, 315 can be inserted, or a combination thereof. In other aspects, the translator component 320 can be implemented in a different manner.

In particular aspects, the request templates 373 correspond to specific operations or methods provided by the remote computer system 325, such as through an interface (e.g., an API) using a web services data access protocol. The request templates 373 can have a one-to-one correspondence with the methods 310, 315, in some cases. In other cases, there may be more or fewer request templates 373 (and/or interface methods of the remote computer system 325) than methods 310, 315.

The request templates 373 can include operations that can be carried out with respect to particular entities (e.g., instances of logical data objects or other abstract or composite data types) stored at the remote computer system 325. The operations can include a GET operation, where information regarding one or more entities, or schema information, can be retrieved, including directly specified entities (or particular information thereof) or entities meeting particular query criteria, a POST operation, where one or more new entities can be created, a PUT operation, where an entity can be replaced with another entity instance, a PATCH operation, where a portion of one or more entities can be updated, and a DELETE operation, where one or more entity instances are removed. These operations can be provided with appropriate arguments from the method calls 310, 315, such as specific entities, or entities meeting particular criteria, to which the operation is to be applied, and, if appropriate, data fields and corresponding values to be added or updated at the remote computer system 325.

Returning to the methods 345, configuration methods 350 can include methods relating to authorization and security and methods relating to the performance of the translator component 320. As an example, an authentication method can be provided that allows a software application 305 to send authorization information, such as a security token, to the translator component 320, which the translator component can use to establish a connection with the data source 325. In some cases, instead of a specific security token (for example, an OData authorization token), one or more other tokens can be used for authorization, such as a user name and password. For example, the method call 310 can have the properties:
URL: http//hostname:port/easy-odata/auth
Http Method Type: POST
Request Body:
   Authorization Token
   Data Source URL
      Where the URL is the location of the API method 345 of the translator component 320 and the Http Method Type specifies that information is being provided to the translator component. The request body includes the authorization token that can be used by the data source 325 to authorize the user to access all or a portion of the data source in subsequent requests in a session. The request body can also include an identifier (e.g., a location identifier) for the data store 325, including particular data of the data store.

As another example of a configuration method 350, a user can be allowed to selectively enable a caching function of the translator component 320. Enabling the caching functionality can, for example, allow some information from the data source 325 to be stored on the translation component 320, allowing information to be more quickly retrieved if it is responsive to future method calls, including storing an authorization token and an identifier (e.g., a URL) for a data source to be accessed, or data read from the data source (e.g., entity/field data retried during a prior method call or metadata describing available entities, and fields thereof, as well as their interrelation, such as in a hierarchy, at the data source). The method call 310 to the translator component 320 can have the properties:
URL: http://hostname:port/easy-odata/cache
Http Method Type: POST
Request Body:
   Value=Enable/Disable (e.g., 0∥1; TRUE∥FALSE)
      Where the URL is the location of the API method 345 of the translator component 320 and the Http Method Type specifies that information is being provided to the translator component.

As mentioned above, in some cases, a user (or an application being accessed by a user) may wish to determine what data is generally available, such as what entities 330 and data fields 335 are available for retrieval. This metadata can be obtained using the following method call (e.g., a type of query method 355):
URL: http://hostname:port/easy-odata/metadata
Http Method Type: GET
   Where the URL is the location of the API method 345 of the translator component 320 and the Http Method Type specifies that information is being retrieved from the translator component. In this method call, the request 310 does not include a body, as the method call automatically returns particular metadata in response to the request. However, in other aspects, the request 310 can include a request body, such as instance of an abstract or composite data type, or a data structure including such objects, to receive information from the data source 325.

This Example, including the aspects further described below, illustrates how the disclosed innovations can simplify the process of an application 305 accessing the data source 325. In prior approaches, a developer would need to understand the format of an OData authorization request, required for accessing the data source 325, including understanding the format of the URL to access the OData API of the data source, the actual URL of the data source, and the information to be included in the request body (including particular formatting, syntax, or code for the body). Using the disclosed innovations, all the application 305 needs to do for the authorization request is call the appropriate method 345 (in this case, the method 350) of the translator component 320, including providing the authorization token and the location of the particular data source 325 that is to be accessed. The conversion engine 375 takes care of inserting these arguments into the shell for the authorization request.

A user (or the software application 305 on behalf of a user), in another example of a query method 355, can request specific data (including all data) by making the appropriate call 310 to the translator component 320. The method call 310 can be of the form:
URL: http://www.hostname:port/easy-odata/entity-name
Http Method Type: GET
Request Body:
   Query options (e.g., filter, select, top, skip)
   Key Value (e.g. userID=2130)
      Where the URL is the location of the API method 345 of the translator component 320 and the Http Method Type specifies that information is being retrieved from the translator component. The entity name can be obtained, for example, using the call to obtain metadata, or may already be known by the user or the software application 305. In some cases, the method call 310 accepts a single value for an entity 330, while in other cases the method call accepts multiple entity identifiers. The Key Value of the request body can identify a particular record (or a field 335 thereof) for which data is to be retrieved (including as specified by the query options).

Update, insert, and delete methods 360 can be carried out using a method call 315 that is similar to the method 310 for retrieving data. The method call 315 can have the form:
URL: http://hostname:port/easy-odata/entity-name
Http Method Type: POST
Request Body:
   Key Value (e.g., userID=2130)
   Field name and value (e.g., lastName=Yuan)
      Where the URL is the location of the API method 345 of the translator component 320, the Http Method Type specifies that information is being provided to the translator component, and the request body includes an identifier of the record to be updated (specified by the key value, which can be an entity identifier 330), a field name (e.g., a field identifier 335) to be modified, and the value 340 to be inserted/updated in the specified field name.

A method 365 can be provided that allows changes to data of the data source 325 to be carried out in a batch process. Apart from specifying multiple value changes 340, for one or more entities 330 (including particular fields 335 thereof), the batch method 365 can be carried out in a similar manner to unitary insert/update operations 360. The method call 315 for a batch method 365 can have the form:
URL: http://hostname:port/easy-odata/batch/entities
Http Method: POST
Request Body:
   Entity Name
   Field names and values
      Where the URL is the location of the API method 345 of the translator component 320 and the Http Method Type specifies that information is being provided to the translator component.

These methods 345 are provided by way of example. A particular translator component 320 can include more, fewer, or different methods 345 than those described. Although the methods 345 are described as being accessed via a specific URL format (such as using REST principles), the interface for a method can be defined in other ways, including using the simple object access protocol (SOAP).

As described above, for certain operations (e.g., operations that access the data source 325, rather than configuration options for the translator component 320), the translator component takes arguments provided by a method call 310, 315 and formats them into an appropriate request that can be sent to, and processed by the, data source 325. As an example, in the OData protocol, a query can be specified in the format:
https://hostname:port/odata/v2/[[request_entity]]/[[request_queryOptions]]
   Where odata specifies that the request is to an OData service and v2 specifies the OData version to be used (e.g., currently both OData version 4 and OData version 2 are used).

The above query request template can be stored in the library 370. When the query method 355 is called by the software application 305, the conversion engine 375 can scan the arguments provided in the method call 310 to make sure they are lexically correct for use in the request, and can parse the arguments for insertion into the query request template 373. In inserting the arguments into the query request template 373, the conversion engine 375 can format the arguments as appropriate for use with the data source 325, including inserting operators and tokens to provide the appropriate syntax for the data source.

As an example, consider a user who wishes to retrieve the names and email addresses for all employees of a human resources department of an organization from the data source 325. The method call 310 from the software application 305 for the query can be structured as described above, where the body of the request includes “employee” as the entity 330, specifies “name” and “email” as the fields 335 to be retrieved, and includes a filter condition of the employee being associated with the human resources department. The conversion engine 375 can insert these arguments into the appropriate request template 373 from the library 370 to provide the following request, which can then be sent to, and executed by, the data source 325.
https://hostname/odata/v2/User?$select=userName,email&$filter=department=‘HR’

In addition to the URL, the conversion engine 375 can generate the message body for the request, which can be specified in a programming language (including a markup language), such as JAVA or JAVASCRIPT. The message body can include schema elements and values (e.g., to be used in a query or to create or update new data object instances), or variables or data objects (e.g., class instances) for receiving execution results. The data objects can be specified according to a schema (e.g., a particular collection of data members having particular types, including data members stored in data structures, such as arrays, stacks, queues, trees, lists, heaps, graphs, and the like).

Execution results can be provided by the remote computer system 325 to the translator component 320. Executions results can include query results, or can include indications that operations were successfully carried out by the remote computer system 325 (e.g., commit notifications). In some cases, the translator component 320 forwards the execution results to the calling software application 305 without additional processing. In other cases, the translator component 320 can format or convert the execution results into a particular format usable by the software application 305. For instance, if the execution results provided by the data source 325 are specified in the OData protocol, the conversion engine 375 can convert the execution results into a return type useable by the software application 305, or can associate execution results with arguments provided by the software application (e.g., with pointers received from the software application). The conversion engine 375 can also map execution results to a particular schema for the software application 305, such as mapping execution results to a particular abstract data type used by the software application. In particular, the mapping can be object-relational mapping.

### Example 3—Example Architecture

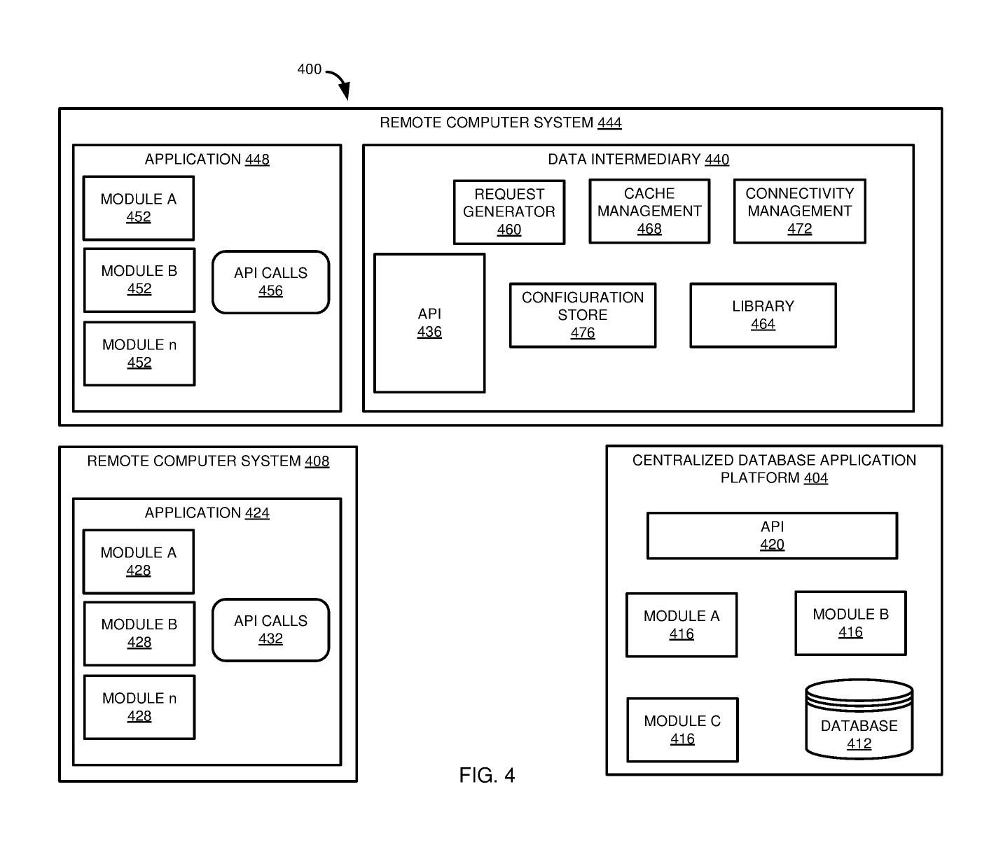

FIG. 4 illustrates an example architecture 400 in which the disclosed innovations can be implemented. The architecture 400 represents a modified version of the architecture 100 of FIG. 1.

The architecture 400 includes a centralized database application platform 404 and a remote computer system 408, which can be analogous to the centralized database application platform 105 and the remote computer system 130 of FIG. 1. In particular, the remote computer system 408 may be a server maintained by an organization associated with one or more end users.

The centralized database application platform 404 can be structured in a similar manner to the corresponding component of FIG. 1, including having a database 412, one or more application modules 416, and an interface 420 (e.g., an application program interface) to provide access (such as to external clients) to the database. In other aspects, the architecture 400 can omit the application modules 416.

Like the remote computer system 130, the remote computer system 408 can include one or more applications 424, each having one or more modules 428. However, rather than including the data service 150, each application 424 makes calls 432 to an interface 436 of a data intermediary 440 of a remote computer system 444. In particular examples, the interface 436 can be implemented as described in Example 2.

The remote computer system 444 can be a centralized cloud platform, as with the remote computer system 125 of FIG. 1. The remote computer system 444 can include one or more applications 448 having one or more modules 452. However, like the application 424, rather than using a data service 150, the application 448 makes calls 456 to the interface 436. The calls 432, 456 can share a common interface. For instance, the calls 432, 456 can both employ a REST architecture in accessing the interface 436.

Although two remote systems or devices 408, 444 are shown, more or fewer systems or devices can be used. In addition, in some scenarios, the architecture 400 can include (and, for example, the remote computer systems or devices 408, 444 can be) computer systems or devices that are not cloud-based, including computer devices such as desktop computers, laptop computers, tablet computing devices, smartphones, and other portable computer devices.

The data intermediary 440 can implement the translator component 320 of FIG. 3. The data intermediary 440 implements the interface 436. In particular, the interface 436 accepts calls from other computer systems and devices (e.g., the computer system 408), or applications executing on the remote computer system 444, and can return responses in response to a call (e.g., indicating that a call was successful or returning data requested in a call).

The data intermediary 440 includes a request generator 460. The request generator 460 can carry out all or a portion of the functions of the conversion engine 375 of FIG. 3. In particular, the request generator 460 can retrieve appropriate request templates from a library 464 and populate them with arguments provided in a call made to the interface 436.

The data intermediary 440 can include a cache management component 468. The cache management component 468 can be used to store data retrieved from the database 412. In some cases, the cache management component 468 can be selectively enabled or disabled, including in response to calls received from a particular user. In other cases, the selection of whether caching functionality should be enabled can be set by a developer for a particular application (or for a particular user or class of users for an application).

A connectivity management component 472 can be included in the data intermediary 440. The connectivity management component 472 can be used to establish a connection, or session, at the centralized database application platform 404 that can be used for calls received through the interface 436. The connectivity management component 472 can, for example, use identifiers for an application and/or user associated with a call, and authentication information (e.g., an OData authorization token) to establish a connection with the centralized application platform 404.

As mentioned, the data intermediary 440 can include a library 464. The library 464 can include templates that can be used in executing various calls to the interface 436. Although a specific example (Example 2) described how a URL could be constructed using a template and arguments provided in a method call, generating a request to be sent to, and executed by, the centralized database application platform 404, such as using the request generator 460 can involve alternative, or additional, steps. For instance, a request sent to the centralized database application platform 404 by the data intermediary 440 can include a message body, in addition to any information that may be included in a URL.

The protocol may be implemented in one or more computer languages (e.g., JAVA or JAVASCRPT), and the one or more languages may have libraries (e.g., libraries of functions or subroutines) used in programs implementing the data intermediary 440, including libraries that can be called in creating or executing programs. The programs can call the library 464 when creating requests for the centralized database application platform 404 (e.g., for requests created by the request generator 460).

For instance, for read requests, in addition to information specified in a URL, a body of the read request may include code specifying how data should be stored and returned, including creating or referencing data structures to hold the data. The library 464 can provide functions, abstract and composite data types, data structures, etc. that can be used to interact with the centralized database application platform 404. Using the library 464 can both speed development of the data intermediary 440, and also help ensure that the code provides expected functionality (e.g., by using standardized, tested, maintained code). In a specific example, the library 464 can include the APACHE OLINGO library, which implements the OData protocol in JAVA or JAVASCRIPT.

The data intermediary can include a configuration store 476. The configuration store 476 can store configuration information for particular users, applications, client computer devices, etc. The configuration store 476 can store, such as for each user, configuration information, such as whether caching has been enabled, authentication information (e.g., an OData authorization token), or entities that have been selected for data retrieval. For instance, the interface 436 can provide a method to select or set an entity for data retrieval. When retrieval calls are received from an application 424, 448 (e.g., specific fields or entity values to be retrieved), the arguments received in the data retrieval call can be combined with the information stored in the configuration store 476 in order to allow the request generator 460 to formulate the request.

In some cases, information can be added to the configuration store 476 using a method call from an application. In other cases, the data intermediary 440 can provide a user interface (including a graphical user interface), that allows a user to set information of the configuration store 476, including uploading authorization tokens, setting cache preferences, and selecting entities to be queried or updated. If desired, the user interface can include additional functionality, such as allowing read and write requests to be entered. The user interface can be integrated with an application 424, 448.

### Example 4—Example Method of Generating a Request to a Data Store Based on Call to Interface Method

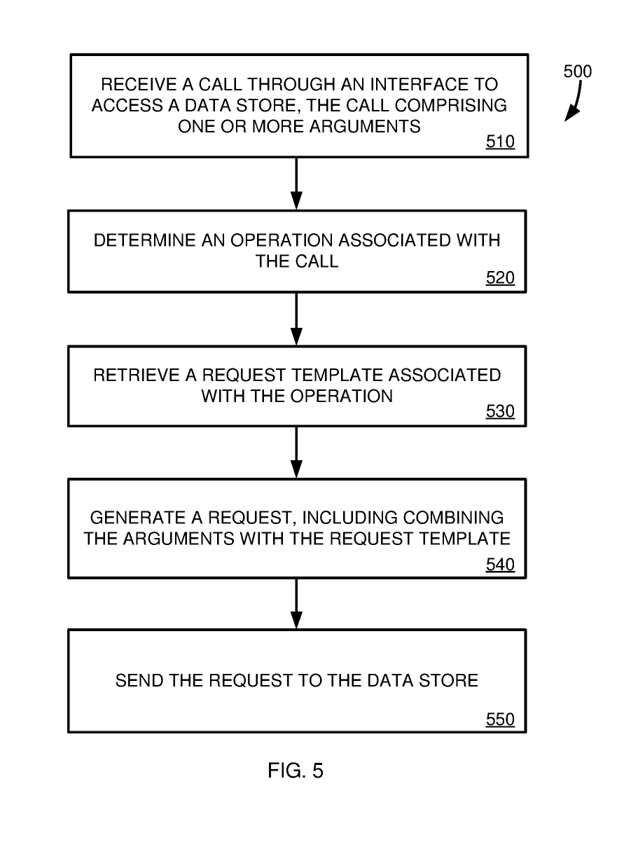

FIG. 5 illustrates an example method 500 for generating a request to be sent to a data store in response to a call from an application to an interface method. The method 500 can be implemented, for example, using the architecture 400 of FIG. 4. At 510, a call is received through an interface. The call requests access to a database, such as to read data from, or write data to, the data store, and includes one or more arguments. An operation associated with the call is determined at 520, such as to read or write data. At 530, a request template associated with the operation is retrieved.

A request to the data store is generated at 540. The generating includes combining at least one of the one or more arguments with the request template. The request is sent to the data store at 550.

### Example 5—Example Construction of a Request to a Request to a Remote Data Store

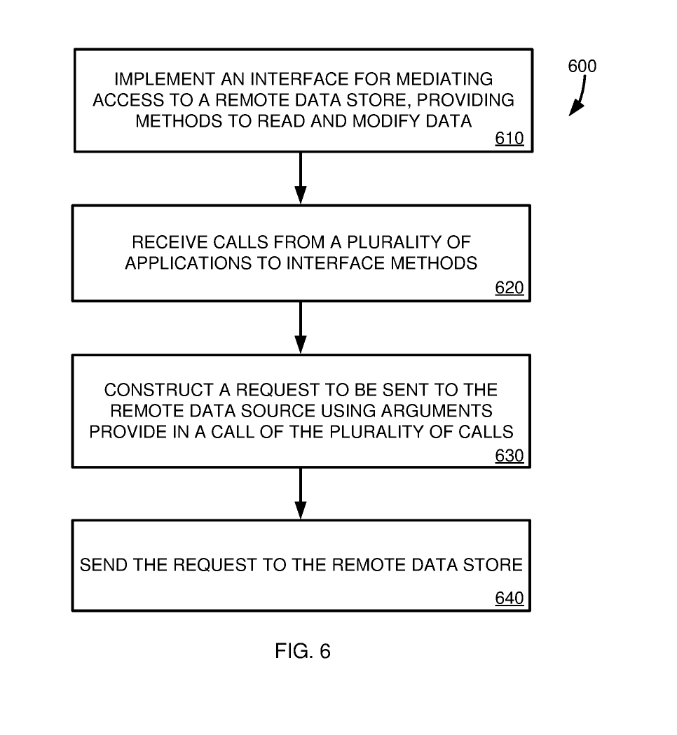

FIG. 6 illustrates an example method 600 for constructing a request to be sent to a remote data store. The method 600 can be implemented, for example, using the architecture 400 of FIG. 4. At 610, an interface is implemented for mediating access to a remote data store. The interface provides methods to read and modify data of the remote data store. Calls from a plurality of applications to interface methods are received at 620. At 630, a request is constructed to be sent to the remote data store. The request uses arguments provided in a call of the plurality of calls. The request is sent to the remote data store at 640.

### Example 6—Example Facilitation of Data Operations at a Remote Data Store

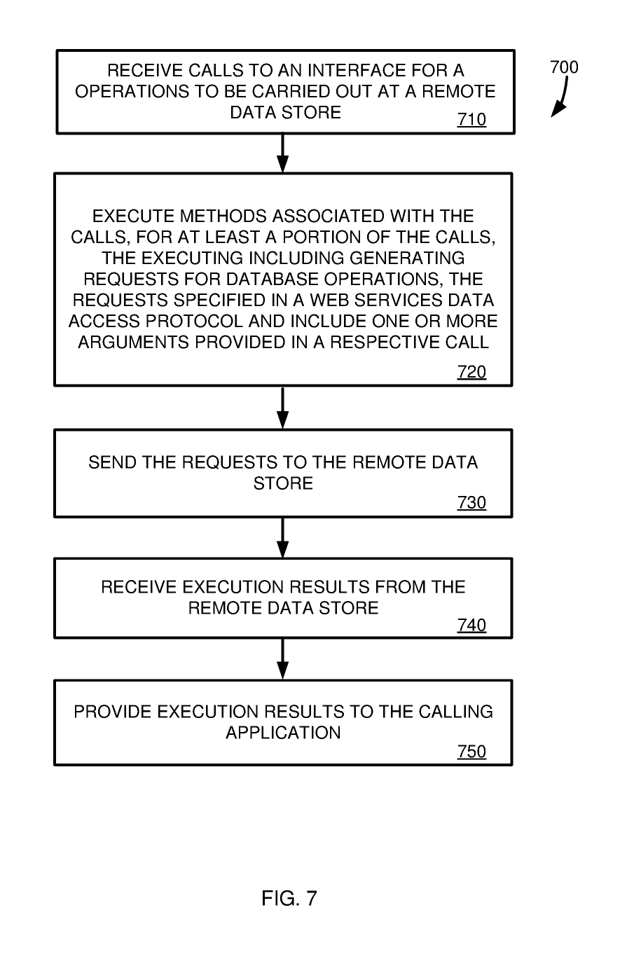

FIG. 7 illustrates an example method 700 for facilitating data operations at a remote data store. The method 700 can be implemented, for example, using the architecture 400 of FIG. 4. At 710 calls to an interface are received, where the calls request operations to be carried out at a remote data store (e.g., a data store that is remote from a call source). Methods associated with the calls are executed at 720. For at least a portion of the calls, the executing includes generating requests for database operations. The requests are specified in a web services data access protocol and include one or more arguments provided in a respective call. The requests are sent to the remote data store at 730.

Execution results are received from the remote data store at 740. The execution results are provided to the calling application at 750.

### Example 7—Example Technical Solution

The technical solution can facilitate interactions of software applications with a centralized data store, which can be located on a computer device or system (e.g., a collection of cooperating computer devices) remote from a computer device on which the software application is executing. The interactions can be facilitated by a translation component, which can be implemented on the same computer device on which the software application is executing or a different computer device.

The translator component provides an interface that abstracts operational details and requirements of the centralized data store from the software applications, facilitating communications between computer systems and devices and improving interoperability between computer systems and devices. Thus, the process of developing applications that can access the centralized data store can be carried out at reduced effort and cost, as developers do not need to know, or be fluent in, the structure of the centralized data store or the protocols used by the centralized data store. Overall, redundant development effort is avoided, as an interface for the centralized data store can be implemented a single time and used by a plurality of software applications, rather than each software application having to implement functionality for accessing the centralized data store. In addition, in at least some aspects, the same interface can be used for both a plurality of software applications and a plurality of centralized data stores.

The disclosed innovations can also provided increased flexibility, as the methods implemented by the translator component can be modified without affecting the software applications using its services. Modifications can include making the code implementing the interface more efficient. Modifications can also include updating the code implementing the interface to use an updated version of a protocol used by the centralized data store, or even a complete change of the protocol used by the centralized data store. Prior to the disclosed innovations, a change or update to the protocol used by the centralized data store may have required the software applications to also be updated if they were to continue to use the services of the remote data store.

The technical solution of the disclosed interface implements methods which can be called by software application to carry out operations at the remote data store. The method calls of the software applications can include arguments that are inserted by a conversion engine of the translator component into requests to be sent to, and executed by, the remote data store.

### Example 8—Example Feature: Translator Component

In any of the inventive examples herein, a translator component can mediate access by a plurality of software applications, which can be located at one or more computer devices, to a centralized data store. Thus, the software applications can use the centralized data store without having to implement functionality to directly access the centralized data store, including generating requests in a particular protocol used by the centralized data store.

### Example 9—Example Computing Systems

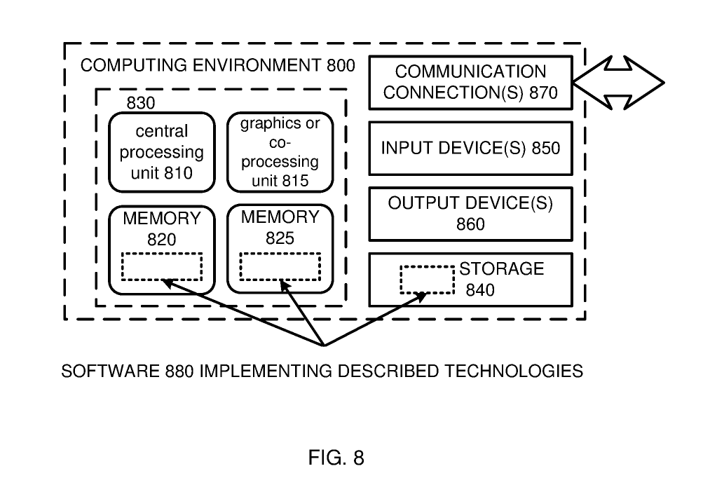

FIG. 8 illustrates a generalized example of a suitable computing system 800 in which several of the described innovations may be implemented. The computing system 800 is not intended to suggest any limitation as to scope of use or functionality, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s), such instructions for logical data object schemas, change requests for to logical data object instances, and update elements.

A computing system may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software 880 implementing one or more innovations described herein. The storage 840 does not include signals per se.

The input device(s) 850 may be a touch input device such as a keyboard, mouse, pen, or trackball, a voice input device, a scanning device, or another device that provides input to the computing system 800. For video encoding, the input device(s) 850 may be a camera, video card, TV tuner card, or similar device that accepts video input in analog or digital form, or a CD-ROM or CD-RW that reads video samples into the computing system 800. The output device(s) 860 may be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general purpose program, such as one or more lines of code in a larger or general purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 10—Example Cloud-Supported Environment

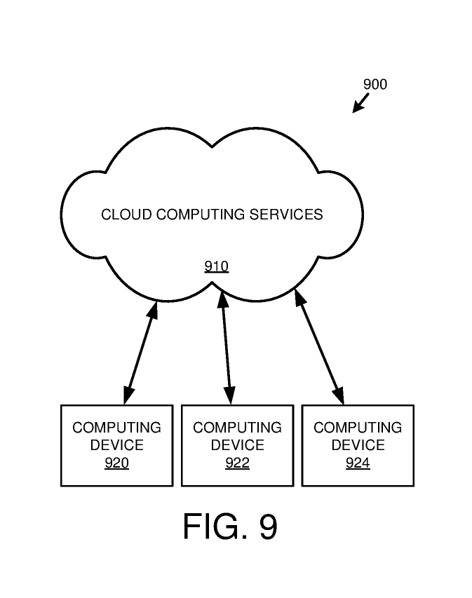

In example environment 900 of FIG. 9, the cloud 910 provides services for connected devices 930, 940, 950 with a variety of screen capabilities. Connected device 930 represents a device with a computer screen 935 (e.g., a mid-size screen). For example, connected device 930 could be a personal computer such as desktop computer, laptop, notebook, netbook, or the like. The connected device 940 represents a device with a mobile device screen 945 (e.g., a small size screen). For example, the connected device 940 could be a mobile phone, smart phone, personal digital assistant, tablet computer, and the like. The connected device 950 represents a device with a large screen 955. For example, the connected device 950 could be a television screen (e.g., a smart television) or another device connected to a television (e.g., a set-top box or gaming console) or the like. One or more of the connected devices 930, 940, 950 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 900. For example, the cloud 910 can provide services for one or more computers (e.g., server computers) without displays.

Services can be provided by the cloud 910 through service providers 920, or through other providers of online services (not depicted). For example, cloud services can be customized to the screen size, display capability, and/or touch screen capability of a particular connected device (e.g., connected devices 930, 940, 950).

In example environment 900, the cloud 910 provides the technologies and solutions described herein to the various connected devices 930, 940, 950 using, at least in part, the service providers 920. For example, the service providers 920 can provide a centralized solution for various cloud-based services. The service providers 920 can manage service subscriptions for users and/or devices (e.g., for the connected devices 930, 940, 950 and/or their respective users).

### Example 11—Computer-Readable Media

Any of the computer-readable media herein can be non-transitory (e.g., volatile memory such as DRAM or SRAM, nonvolatile memory such as magnetic storage, optical storage, or the like) and/or tangible. None of the computer-readable media herein include signals per se. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 12—Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. All that comes within the scope and spirit of the claims is therefore claimed as the invention.

What is claimed is:

1. One or more computer-readable media comprising computer-executable instructions that when executed cause a computing system to perform processing to process a call for data store services, the processing comprising:
receiving a call through an interface to access a data store, the call comprising one or more arguments;
determining an operation associated with the call;
retrieving a request template associated with the operation;
generating a request, the generating comprising combining at least one of the one or more arguments with the request template; and
sending the request to the data store.

2. The one or more computer-readable media of claim 1, wherein the request is specified in a web services data access protocol.

3. The one or more computer-readable media of claim 2, wherein the web services data access protocol is the OData protocol.

4. The one or more computer-readable media of claim 1, the processing further comprising:
receiving data from the data store in response to the request;
mapping the data to a schema; and
sending the mapped data is response to the call.

5. The one or more computer-readable media of claim 1, the processing further comprising:
extracting one or more values from an instance of an abstract data type provided as an argument of the call; and
formatting the extracted one or more values for insertion in a database.

6. The one or more computer-readable media of claim 1, wherein the interface is specified in a web services protocol.

7. The one or more computer-readable media of claim 1, wherein the interface is implemented in the hypertext transfer protocol.

8. The one or more computer-readable media of claim 1, wherein the call is from a plurality of calls to the interface, the plurality of calls originating from a plurality of software applications.

9. The one or more computer-readable media of claim 1, wherein the call is from a plurality of calls to the interface, the plurality of calls originating from a plurality of computer devices.

10. The one or more computer-readable media of claim 1, the processing further comprising:
receiving data form the data store in response to the request;
caching at least a portion of the data; and
sending at least a portion of the data in response to the call.

11. The one or more computer-readable media of claim 1, wherein at least a portion of the request comprises operations specified in the structured query language.

12. The one or more computer-readable media of claim 1, wherein the call is associated with a user and the processing further comprises:
receiving user metadata; and
storing the user metadata.

13. The one or more computer-readable media of claim 1, wherein the generating comprises generating a URI associated with the data store.

14. The one or more computer-readable media of claim 13, wherein the generating comprises generating an instruction body to be processed by the data store.

15. The one or more computer-readable media of claim 1, wherein the request is made to an interface provided by the data store.

16. The one or more computer-readable media of claim 1, wherein the data store is a remote data store as to a source of the call.

17. The one or more computer-readable media of claim 16, wherein the remote data store is coded to service data requests from a plurality of computer devices.

18. A system comprising:
memory;
one or more hardware processors coupled to the memory;
one or more computer-readable media storing instructions that, when loaded into the memory, cause the one or more hardware processors to perform operations for:
implementing an interface for mediating access to a remote data store, the interface providing methods comprising a method to read data at the remote data store and at least one method to modify data at the remote data store;
receiving calls from a plurality of applications to interface methods, at least a portion of the plurality of calls providing one or more arguments for a called method;
constructing a request to be sent to the remote data store using at least one of the one or more arguments provided in a call of the plurality of calls, the request comprising a URI and a request body; and
sending the request to the remote data store.

19. The system of claim 18, the operations further comprising:
receiving a response to the request from the remote data store;
formatting data associated with the request response to be sent to the calling application; and
sending the formatted data to the calling application.

20. A method implemented at least in part by a computing system, the method comprising:
receiving calls to an interface for facilitating access to a remote data store from a plurality of software applications executed on a plurality of different computer devices, each call being specified in a web services protocol and the interface providing a method to read data from the remote data store and at least one method to modify data at the remote data store;
executing methods associated with the calls, wherein, for at least a portion of the calls, the executing comprises generating requests for database operations, the requests specified in a web services data access protocol, the requests having a URI and a request body, and comprising one or more arguments provided in a respective call;
sending the requests to a web services interface of the remote data store;
receiving execution results from the remote data store; and
providing execution results to the calling applications.
